(19) United States
(12) Patent Application Publication
(10) Pub. No.: US 2023/0162228 A1
(43) Pub. Date: May 25, 2023

(54) METHOD AND SYSTEM TO ASSESS IMAGE ADVERTISEMENTS

(71) Applicants: Northwestern University, Evanston, IL (US); University of Maryland, College Park, College Park, MD (US)

(72) Inventors: Ulf Bockenholt, Evanston, IL (US); Kunpeng Zhang, Greenbelt, MD (US)

(21) Appl. No.: 17/991,110

(22) Filed: Nov. 21, 2022

Related U.S. Application Data
(60) Provisional application No. 63/281,996, filed on Nov. 22, 2021.

(51) Int. Cl. G06Q 30/0242; G06T 7/00

(52) U.S. Cl. CPC G06Q 30/0242; G06T 7/0004; G06T 2207/20081; G06T 2207/20084

(57) ABSTRACT

A system to predict success of advertisements includes a memory configured to store an advertisement, and a processor operatively coupled to the memory. The processor is configured to identify one or more features of an image included in the advertisement, and to identify similarities between the one or more features and one or more defined attributes. The processor also determines a typicality of the advertisement based at least in part on the similarities between the one or more features and the one or more defined attributes. The processor also assigns a likelihood of success score to the advertisement based at least in part on the typicality.

### CROSS-REFERENCE TO RELATED APPLICATION

The present application claims the priority benefit of U.S. Provisional Patent App. No. 63/281,996 filed on Nov. 22, 2021, the entire disclosure of which is incorporated herein by reference.

### BACKGROUND

Fast-food is a 200-billion-dollar industry in the United States alone, with close to 200,000 quick-service restaurants and over 70 different restaurant chains. Most of these fast-food (FF) chains are on Facebook, Pinterest, Instagram, or TikTok, spending an increasing fraction of their $3+ billion advertising budget on social media marketing. They also face the shared challenge of cutting through the clutter with image ads that are engaging, that create favorable thoughts, and that are remembered. For example, measures of image-ad success in terms of engagement and favorable thoughts are available on major social media platforms (e.g., Facebook, Instagram, Twitter) via their ‘share’ or ‘like’ buttons, as well as similar actions such as ‘saving’ on Pinterest. Because only a subset of visual ads succeed in being memorable, liked, and shared, predicting what makes an image ad successful is highly relevant for the industry.

### SUMMARY

An illustrative system to predict success of advertisements includes a memory configured to store an advertisement, and a processor operatively coupled to the memory. The processor is configured to identify one or more features of an image included in the advertisement, and to identify similarities between the one or more features and one or more defined attributes. The processor also determines a typicality of the advertisement based at least in part on the similarities between the one or more features and the one or more defined attributes. The processor also assigns a likelihood of success score to the advertisement based at least in part on the typicality.

In one embodiment, the one or more features include one or more object words. In another embodiment, the one or more features include a depiction of an item of food. In an illustrative embodiment, the processor is further configured to identify a relational feature between objects within the image included in the advertisement. In such an embodiment, the processor determines the typicality of the advertisement based at least on part on the relational feature between the objects within the image.

In another embodiment, the processor is configured to estimate a level of interest in the advertisement based at least in part on the similarities between the one or more features and the one or more defined attributes. The likelihood of success score can be based at least in part on the estimated level of interest. In another embodiment, the processor is configured to estimate a level of enjoyment that the advertisement provides based at least in part on the similarities between the one or more features and the one or more defined attributes. In such an embodiment, the likelihood of success score is based at least in part on the estimated level of enjoyment. The processor is also configured to estimate a fluency level of the advertisement based at least in part on the similarities between the one or more features and the one or more defined attributes. In such an embodiment, the likelihood of success score is based at least in part on the estimated fluency level. In another embodiment, the processor is configured to estimate an amount of complexity of the advertisement based at least in part on the similarities between the one or more features and the one or more defined attributes. The likelihood of success score can also be based at least in part on the estimated amount of complexity.

In one embodiment, the one or more defined attributes indicate a likelihood of sharing. In another embodiment, the one or more defined attributes indicate a likelihood of being liked on social media. In another embodiment, the one or more defined attributes indicate a likelihood of being remembered.

An illustrative method of predicting success of advertisements includes storing, in a memory, an advertisement. The method also includes identifying, by a processor operatively coupled to the memory, one or more features of an image included in the advertisement. The method also includes identifying, by the processor, similarities between the one or more features and one or more defined attributes. The method also includes determining, by the processor, a typicality of the advertisement based at least in part on the similarities between the one or more features and the one or more defined attributes. The method further includes assigning, by the processor, a likelihood of success score to the advertisement based at least in part on the typicality.

In another embodiment, the method includes identifying, by the processor, a relational feature between objects within the image included in the advertisement and determining, by the processor, the typicality of the advertisement based at least on part on the relational feature between the objects within the image. In another embodiment, the method includes estimating, by the processor, a level of interest in the advertisement based at least in part on the similarities between the one or more features and the one or more defined attributes, where the likelihood of success score is based at least in part on the estimated level of interest. In one embodiment, the method includes estimating, by the processor, a level of enjoyment that the advertisement provides based at least in part on the similarities between the one or more features and the one or more defined attributes, where the likelihood of success score is based at least in part on the estimated level of enjoyment.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a first image used to help determine what consumers share most in accordance with an illustrative embodiment.

FIG. 1B is a second image used to help determine what consumers share most in accordance with an illustrative embodiment.

FIG. 1C is a third image used to help determine what consumers share most in accordance with an illustrative embodiment.

FIG. 2A is a first image used to help determine what consumers like most in accordance with an illustrative embodiment.

FIG. 2B is a second image used to help determine what consumers like most in accordance with an illustrative embodiment.

FIG. 2C is a third image used to help determine what consumers like most in accordance with an illustrative embodiment.

FIG. 3A is a first image used to help determine what consumers remember most in accordance with an illustrative embodiment.

FIG. 3B is a second image used to help determine what consumers remember most in accordance with an illustrative embodiment.

FIG. 3C is a third image used to help determine what consumers remember most in accordance with an illustrative embodiment.

FIG. 4 depicts conjectured links for the framework to relate constructs of image perceptions to ad-success metrics in accordance with an illustrative embodiment.

FIG. 5 presents the marginal distributions as well as the joint relationships between ad measures (with a loess function to highlight any dependencies) in accordance with an illustrative embodiment.

FIG. 6 depicts the loess functions obtained for the object-, relational-, and pixel-based typicality measures and the typicality ratings for the full data set obtained in Study 1 in accordance with an illustrative embodiment.

FIG. 7 shows that the loess functions for the fourteen complexity measures in predicting the complexity rating are close-to-linear in accordance with an illustrative embodiment.

FIG. 8 shows that the loess functions for the fourteen computational fluency measures in predicting the ease rating are close-to-linear in accordance with an illustrative embodiment.

FIG. 9 displays a scatter plot of the summed importance weights for the pleasant and warm attributes against the corresponding summed word2vec scores for the top 10% of the identified features in accordance with an illustrative embodiment.

FIG. 10 depicts a scatter plot of the importance weights for the engaging and interesting attributes versus corresponding word2vec scores in accordance with an illustrative embodiment.

FIG. 11 depicts a table that reports the means of the measures of liking proportions, sharing proportions, and memorability of ads in accordance with an illustrative embodiment.

FIG. 12 is a table of fit statistics that point to satisfactory fits for each of the three FF chains supporting the configural-invariance hypothesis that the structural specification across the three data sets is identical in accordance with an illustrative embodiment.

FIG. 13 is a table that presents the estimated standardized path coefficients as well as the latent-variable R² statistics in predicting memorability, liking, and sharing in accordance with an illustrative embodiment.

FIG. 14 is a table that reveals a three-factor structure (accounting for 74% of the total variance) with pixel-based measures forming one dimension in accordance with an illustrative embodiment.

FIG. 15 is a table of factor loadings and importance weights of fluency measures in accordance with an illustrative embodiment.

FIG. 16 depicts results obtained when using the computational scores of the hold-out sample in accordance with an illustrative embodiment.

FIG. 17 is a table that depicts average estimated reliability coefficients with their standard errors for the ratings obtained in Study 1 in accordance with an illustrative embodiment.

FIG. 18 contains the reliability estimates for the discrimination, sharing, and liking measures in accordance with an illustrative embodiment.

FIG. 19 is a block diagram of a computing device for implementing the system described herein in accordance with an illustrative embodiment.

### DETAILED DESCRIPTION

Described herein are methods and systems to measure ad effectiveness. Specifically, the proposed system predicts the degree to which consumers like, share, and remember image ads. Such a system is of much interest to social media marketing agencies. These agencies face the challenge of developing image ads for social media platforms and other clients that are engaging, memorable, and able to create favorable thoughts in viewers. The proposed system allows these agencies to make rational image ad selections in an automated way. As discussed in more detail below, the proposed system uses scalable computational measures of a plurality of different psychological constructs that, in conjunction, predict the success of image ads. These computational measures are validated using human survey data.

Successful image ads are liked, shared, and remembered. Although the success of an image ad can often be understood with the benefit of hindsight, it is less clear how to predict whether an image ad will be received favorably by its target group. Described herein is a framework to disentangle image-related factors that influence liking, sharing, and recognition responses. The proposed framework is tested with the help of Facebook image ads posted by three fast-food chains. Both human judgments and computational measures of aesthetic features of image ads allow for important insights into how image ads are processed perceptually. Moreover, the framework in combination with the computational measures provides significant benefits for image-ad effectiveness research. Namely, it is highly predictive of an image ad's performance, easy to implement, and scalable.

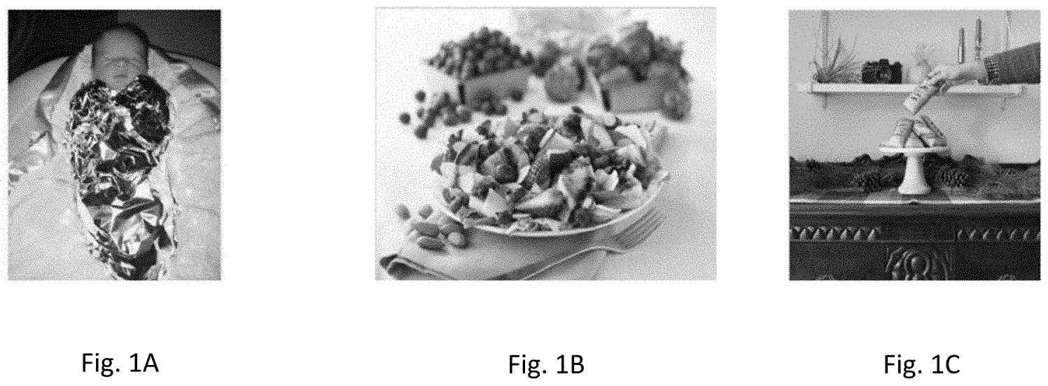

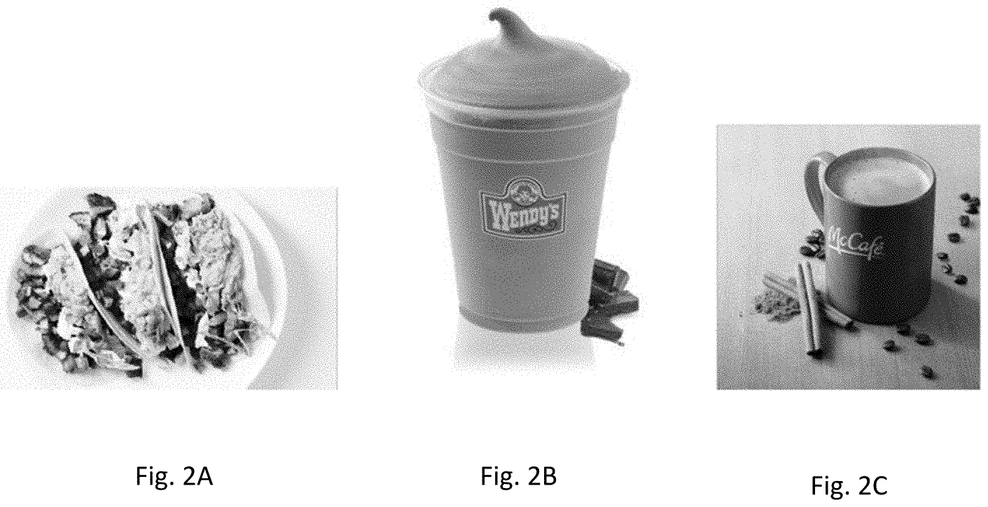

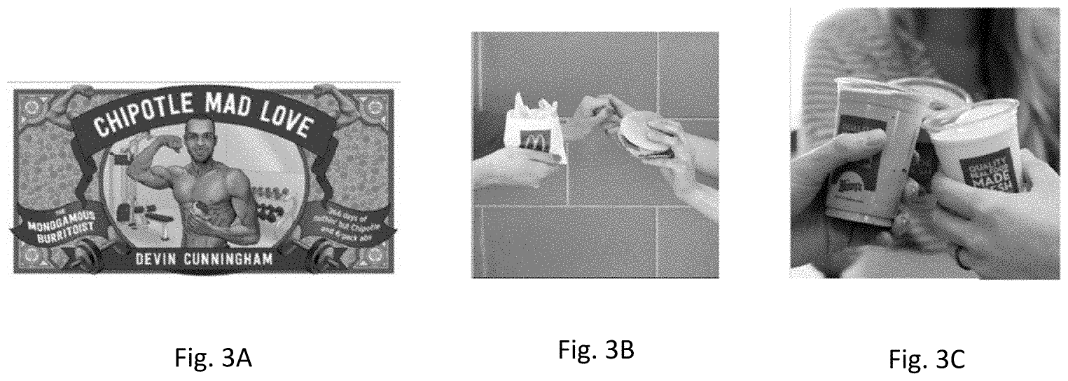

To test the proposed theoretical framework, consumers were asked to consider various sets of fast-food image ads and to assess which of them is shared most often (FIG. 1), which one of them is liked most often (FIG. 2), and which one of them is remembered best (FIG. 3). An even more challenging problem is to predict which of the nine images of FIGS. 1-3 is liked, shared, and remembered most often. Results of the analysis involving FIGS. 1-3 is discussed below.

Although the success of an image ad can often be understood with the benefit of hindsight, the examples demonstrate that the task of predicting whether an image ad will be received favorably is difficult. Described herein is a new approach that may prove effective in predicting whether an image ad will be liked, shared, and recognized on the basis of image features alone. Specifically, the inventors identify predictive image features using a theoretical framework that specifies three behavioral success outcomes to be caused partially by internal aesthetic responses to features of the image ads. Subjective experiences of interest and enjoyment are the two major dimensions of these aesthetic responses, which in turn are driven by the fluency, complexity, and typicality features of the images.

The inventors utilized a structural measurement approach to estimate the effects of the five constructs and to test the proposed theoretical framework. All five constructs—interest, enjoyment, fluency, complexity, and typicality—are measured via human judgments in multiple studies. In alternative embodiments, fewer, additional, and/or different constructs may be used. A path model that utilizes measures of the five constructs at the image level is used to test and validate the theoretical framework. To facilitate the scalability of the approach, the inventors also examined computational measures of the five constructs and proposed new ones to obtain a more complete representation of the considered constructs. These algorithms are based on perceptual (pixel-based) and semantic (object-based) image-ad characteristics, and yield readily interpretable measures of the five constructs. Computational measures provide a number of important benefits, one of which is the lack of potential confounds introduced when working with real-life stimuli. Using these computational measures, the inventors replicated most of the findings obtained with human judgments. In addition, the inventors show that the approach can be employed readily for the identification of image ads that score jointly above average on the considered ad success measures.

This work brings together several lines of research, including how visual factors shape human perception and interpretation of image ads, how they affect the liking, sharing, and memorability of image ads, and what computer-vision features predict perceptual and interpretational processes. Specifically, it is shown that for image ads for three fast-food (FF) chains, Chipotle, McDonald's and Wendy's, the interest elicited by an ad as well as its level of typicality and complexity predicts its memorability. In contrast, the enjoyment and interest elicited by image ads predict their liking and sharing and mediate fluency, complexity, and typicality effects.

Initially presented herein is a theoretical framework for the joint prediction of the three ad-success measures. The inventors also reviewed the literature about the considered constructs of typicality, complexity, fluency, interest, and enjoyment, reported the empirical approach to test the framework, and presented the empirical findings. Subsequently, the inventors examined and developed computational measures of the five constructs. These computational measures are used in place of human judgments and their performance in predicting the three ad-success measures has been assessed. The description concludes with a discussion of the key results and an outlook for the future.

As mentioned above, to test the proposed theoretical framework, consumers were asked to consider sets of fast-food image ads (FIGS. 1-3). FIG. 1 depicts ads that differ systematically in their degree of being shared, FIG. 2 depicts ads that differ systematically in their degree of being liked, and FIG. 3 depicts ads that differ systematically in their degree of being remembered. Specifically, FIG. 1A is a first image used to help determine what consumers share most in accordance with an illustrative embodiment. FIG. 1B is a second image used to help determine what consumers share most in accordance with an illustrative embodiment. FIG. 1C is a third image used to help determine what consumers share most in accordance with an illustrative embodiment. FIG. 2A is a first image used to help determine what consumers like most in accordance with an illustrative embodiment. FIG. 2B is a second image used to help determine what consumers like most in accordance with an illustrative embodiment. FIG. 2C is a third image used to help determine what consumers like most in accordance with an illustrative embodiment. FIG. 3A is a first image used to help determine what consumers remember most in accordance with an illustrative embodiment. FIG. 3B is a second image used to help determine what consumers remember most in accordance with an illustrative embodiment. FIG. 3C is a third image used to help determine what consumers remember most in accordance with an illustrative embodiment. Based on consumer input, the sharing order of the fast-food images of FIG. 1 is FIG. 1A, FIG. 1B, and FIG. 1C. In FIG. 2, the liking order of the fast-food images is FIG. 2C, FIG. 2A, and FIG. 2B in FIG. 2. The remembering order of the fast-food images in FIG. 3 is FIG. 3B, FIG. 3C, and FIG. 3A.

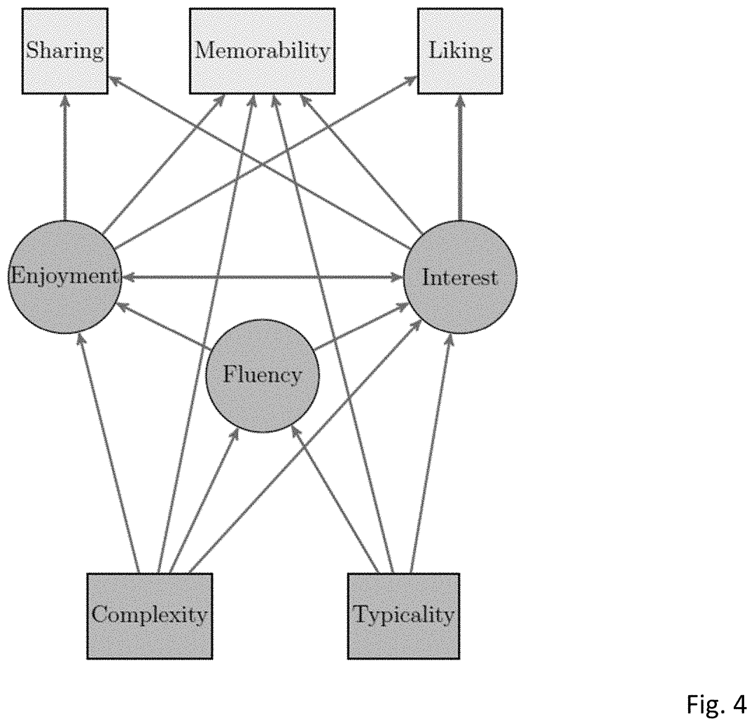

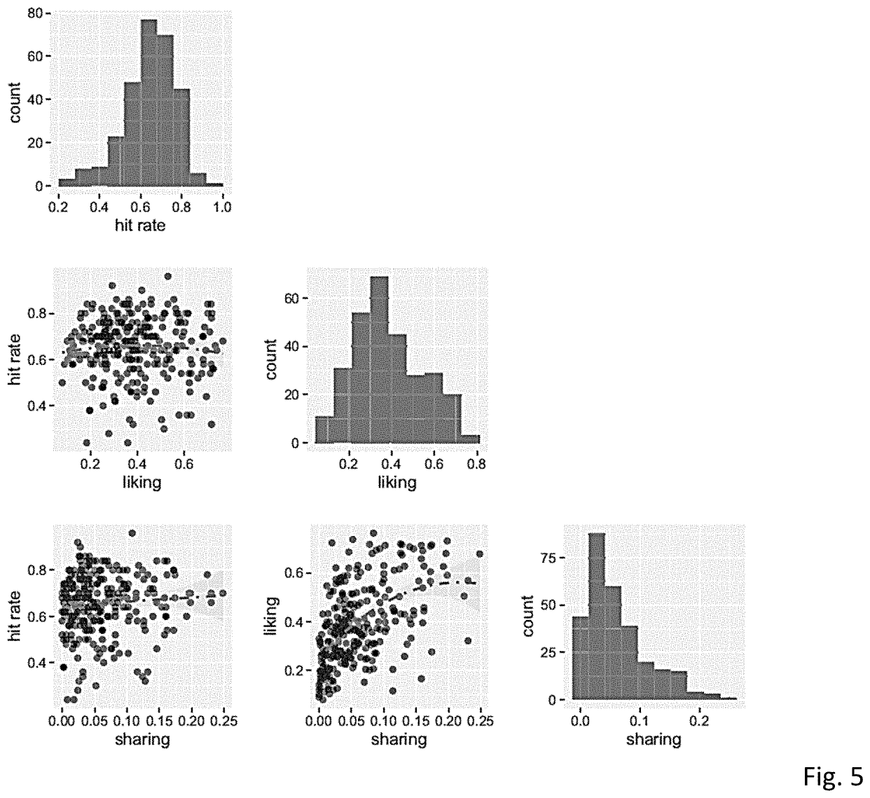

Included below is a description of a conceptual framework to relate the considered constructs of image perceptions to the three ad-success metrics of liking, sharing, and memorability. FIG. 4 depicts conjectured links for the framework to relate constructs of image perceptions to ad-success metrics in accordance with an illustrative embodiment. Complexity and typicality are fundamental image characteristics that give rise to a feeling of visual fluency in an image ad. Moreover, these image attributes trigger interest and enjoyment which, in turn, predict liking, sharing, and memorability outcomes. The critical features of this framework are that fluency acts as a partial mediator of typicality and complexity effects. In contrast, enjoyment and interest act as full mediators of fluency, complexity, and typicality effects for sharing and liking. It is also conjectured complexity and typicality have direct effects on memorability, as shown in FIG. 4.

Many of these conjectured links (and lack of links) are based on studies of aesthetic judgments that look at subsets of these constructs in isolation. However, as noted below, because the links between interest and enjoyment and their effects on the memorability of images have received little attention in the literature, the inventors also include previously unexamined hypotheses in the path diagram. These hypotheses turn out to be important because often fast—food images have appetizing features that may elicit both enjoyment and interest reactions which, in turn, may affect their memorability.

The inventors focused first on enjoyment and interest as the central predictors of the considered ad-success measures. Subsequently, the inventors explored the effects of fluency on enjoyment and interest and the effects of typicality and complexity on fluency, enjoyment, and interest. Also examined are direct effects on the ad-success measures and links to computational measures of the constructs, a topic that is discussed in more detail below.

Regarding enjoyment and interest, there is much research to suggest that feelings of enjoyment and interest play a central role in affecting the memorability of images as well as their liking and sharing. Interest and enjoyment have been shown to be the two dominant dimensions in studies of aesthetic judgments of photographs, paintings, music, polygons, and anagrams. Enjoyment, measured by self-rated feelings of pleasure and warmth, may not only trigger image liking, but it may also help predict recognition and sharing of image ads when enjoyment is caused by the ease in the perceptual processing of the images. One key stage in this perceptual processing is the segmentation of an image into objects and background features. For example, figure-ground compositions having a focal figure with a rather uniform background are perceptually simpler than image scenes that lack a clear central figure or uniform background. Such perceptual distinctiveness facilitates memorability because it requires less effort to process. As a result, memorability has been found to be higher for images that contain one or a few objects that are presented both close-up and in an uncluttered. Moreover, the resulting relative ease in image processing is experienced as pleasant. The inventors return to these positive hedonic processing reactions below when discussing the fluency construct.

When enjoyment is experienced in the form of amusement, it is often associated with an arousal-boosting mechanism that facilitates deeper processing that can increase both an ad's memorability and its sharing. For example, it has been demonstrated that video-induced feelings of amusement made content sharing more likely than video-induced feelings of contentment did.

Interest is defined as an affective state that results from a joint appraisal of the novelty—complexity dimensions of a stimulus and a person's ability to make sense of it. Thus, interest motivates people to explore image ads that are not understood but are understandable. An implication of this definition is that interest requires more effort than does enjoyment. Making sense of novel or complex image ads by elaborating on new and existing schemas and knowledge requires cognitive resources. This sense-making process can facilitate the recognition of image ads. Specifically, it has been shown that visual memory is positively affected by the meaning of displayed objects and scenes. In fact, a person's capacity to remember visual information may depend more on conceptual than perceptual distinctiveness.

The majority of the considered image ads in the studies depict fast-food products. It is likely that arousal and attention may be higher for food-product images because one of the primary brain functions is to locate nutritious and high-energy food. Thus, image ads of fast-food can be particularly potent in creating interest because they are appetizing. Importantly, it has been shown that content which appears interesting and arousing (or novel) is more likely to be shared. Moreover, in an analysis of a random sample of Instagram photos, it has been observed that food images are one category of photos that are most often shared.

Feelings of enjoyment and interest are important predictors of liking, sharing, and memorability for an image. Enjoyment and interest also share similar processing mechanisms. In particular, they share arousal-boosting processes triggered by feelings of amusement and excitement. Image ads that elicit these feelings are likely to elicit both enjoyment and interest. In this case, enjoyment and interest are likely to be positively related and similarly predictive of liking, sharing, and memorability. Moreover, enjoyment and interest may also respond to similar antecedents albeit in different ways. Enjoyment has been found to be reduced for more complex stimuli but increased for more familiar stimuli. In contrast, by demanding investment in cognitive resources, complexity can increase interest, whereas images that are easily processed can decrease interest but increase enjoyment. The inventors discuss these antecedents in more detail below.

Regarding fluency, as depicted in FIG. 4, the degree to which the mental processing of an image ad can elicit subjective feelings of ease or fluency is affected by the ad's typicality and complexity characteristics. For example, it has been shown that a perceptual fluency experience can result from the ease of processing such perceptual stimulus features as symmetry or visual clarity. Moreover, perceptual fluency can be amplified by presenting more typical and less complex stimuli, by increasing the vividness of a contrast against its background, or by repeated exposure. In these cases, the experience of fluency is determined by stimulus characteristics that are nonspecific to its content. Thus, prior exposure to brands or image ads is not needed. However, in addition to experiences of perceptual fluency caused by basic image features, it has been shown that the ease of mental operations to make sense of a stimulus can also lead to a fluency experience. Because this experience is driven by the ease of processing goals or functions associated with a product, it is referred to as conceptual fluency.

Both perceptual and conceptual fluency can elicit positive affect because the ease in processing both visual details and the meaning of an image is pleasurable. It is less clear whether fluency also increases interest. It has been argued that disfluency can feel stimulating and increase interest, especially in novelty-seeking contexts. However, this observation may depend on the product category. In the automobile category, it was found that fluency measures were effective in predicting interest in frontal-car characteristics.

The extant evidence on a direct link between processing fluency and memorability is mixed. There is strong evidence for the perceptual fluency hypothesis, which states that easily processed items are remembered better. However, when taking memory performance into account, it appears that processing fluency can hinder or not affect recall and recognition memory. For example, in several behavioral and electrophysical studies, it was found that perceptual fluency impairs subsequent recollection by reducing later episodic encoding activities. Similarly, it was shown that disfluency, as opposed to fluency interventions, led to improved memory performance in educational outcome measures. In contrast, other studies have shown that that perceptual fluency did not affect subsequent recognition memory. In view of these inconsistent results, no strong predictions can be made about a direct effect of image ad fluency on subsequent recognition memory.

Regarding typicality, the ability to categorize information is fundamental to the acquisition of knowledge and accumulation of experiences. Categories involve mental representations that encode key aspects of category members. Here, typicality is a critical property of a category that reflects its graded structure, with category members differing in the degree to which they are viewed as typical for the category. For example, a hamburger is more often judged to be a typical member of the fast-food category than corn on the cob. Similarly, in category-verification tasks, typical members of a category are identified more quickly and more accurately than less typical ones.

It is well established that perceived typicality—the degree to which objects are viewed as representative of their category—facilitates fast and efficient processing of visual information. Thus, typicality plays a significant role in the processing of image ads. In a fraction of a second, people can identify brands in ads and infer the meaning of the ad. This speed advantage holds in particular for ads that are typical of their product category. Moreover, the resulting efficiency gain gives rise to an experience of perceptual ease or fluency which in turn may lead to a positive hedonic reaction (e.g., enjoyment). In other words, processing ease often mediates the influence of typicality on enjoyment.

It has also been demonstrated in studies involving ads from different product categories that the increased speed and ease with which typical ads are processed are already associated with feelings of interest after a single eye fixation and mediated by the gist of an ad. In contrast, atypical ads, which may require more mental resources to process, are less likely to generate immediate interest. Although these findings are limited to severe exposure time constraints with a single eye fixation, the processing advantages of typical ads remain valid in general. It is less clear, however, whether these initial typicality advantages carry over to an increased feeling of interest under self-terminating exposure situations. The inventors have tested for this possibility and included a link between typicality and interest in FIG. 4.

The inventors also analyzed ad complexity. Because perception and perceptual memory are based on capacity-limited systems, mechanisms for efficient data compression are essential to optimize the amount of information that can be processed and stored. One example of such a data compression mechanism is reflected by the joint photographic experts group (JPEG) image standard, which exploits several biological properties of human sight. By taking into account the insensitivity to variation in color compared to luminance and the relative insensitivity to high spatial frequencies, JPEG compression provides substantial storage savings since it does not require excess fidelity that cannot be processed by human vision.

Visual complexity is a broad construct that has been defined in multiple ways across a wide range of disciplines including computer vision, psychophysics, and cognitive psychology. Definitions relate to the level of intricacy and details in an image, the level of difficulty a human observer encounters in describing an image, or the degree of visual clutter and amount of information conveyed in an image as measured by image-compression algorithms. In view of these multiple distinctions, it is likely that complexity is a multidimensional construct with possibly different effects caused by each dimension.

Support for this observation was provided by the introduction of the important distinction between feature complexity, which depends on basic image features, and design complexity, which further depends on such creative design choices as shapes, objects, and their arrangements. In a large-scale eye-tracking study of image ads, it was found that feature complexity reduced both attention and attitudes towards an ad, whereas design complexity increased both attention and attitudes towards an ad, which in turn improved ad comprehensibility. Since the processing of complex pictures requires more cognitive resources, it is possible that observers allocate more resources to design complexity because design complexity may facilitate an understanding of an image ad more effectively than basic feature complexity. Thus, design complexity can increase interest whereas feature complexity can reduce enjoyment.

To date, theoretical and empirical research on the role of stimulus complexity on memory for affective material has been scant and contradictory. The contrasting findings may partly be explained by the type of stimuli (e.g., natural scenes vs. line drawings) and differences in the definitions of perceptual complexity. However, there is support for the hypothesis that image ads that are more difficult to process and less well understood, are also less well recognized. The inventors therefore conjecture that ad complexity can affect interest, fluency, and enjoyment. In view of these multiple pathways, it is also likely that complexity affects memorability both directly and indirectly. Specifically, it has been suggested that visual complexity may have a direct influence on memorability that is not mediated by enjoyment or interest. It was found that visually more complex images are also more likely to be recognized in a memory task. For this reason, the inventors include a direct path between complexity and memorability in FIG. 4.

Included below are the results of empirical studies (n=6,900) designed to estimate the links among the five constructs. Facebook Graph API was used to download image ads and their likes and comments. The inventors downloaded all images from the first day the page was created for three fast-food chains, McDonald's, Wendy's, and Chipotle. The images were sorted into five quantiles based on the number of “likes” they received. Subsequently, the inventors randomly picked 20 images from each group. The resulting 100 images for each of the three fast-food chains were used in five studies, which are described below.

The first study focused on measuring the perception of the images with regard to the proposed five constructs. The images were presented to three groups of 600 Amazon Mechanical Turk (AMT) workers (with an approval rate of at least 95%) according to a PBIB (Partially Balanced Incomplete Block) design. Under this design, each image and all pairs of images were evaluated by the same number of respondents. Specifically, each participant rated five images on the following seven items using a seven-point bipolar scale that includes the following questions: How interesting do you find the image? How complex does it feel to look at the image? How pleasant does it feel to look at the image? How typical is this image for <McDonald's, Wendy's, Chipotle>? How easy is the image to understand? What is your overall feeling towards this image? How engaging is this image?

It is noted that single items were used for measuring fluency, complexity, and typicality. This was done for two reasons. First, as demonstrate herein, single items are sufficient to assess measurement error at the ad-image level. Second, it has been shown that fluency and typicality, respectively, can be measured reliably with single items at the person level. However, to gain additional power in predicting the three ad-success measures, the inventors used two items for measuring enjoyment and interest.

After their assessments of the five images, participants were asked two binary questions about their willingness to “like” and “share” each image if they saw it on Facebook. If respondents clicked on the share button, they were asked to type a comment to accompany the shared image. As noted below, the inventors did not use the original liking and sharing counts in the analyses because of endogeneity issues. Asking for “likes” and “shares” in this way may lead to a higher response rate than the ads would obtain in the original social media setting. However, as shown, the quantile categorization that gave rise to the initial selection of the images is consistent with the quantile categorization based on the “likes” and “shares” of the samples.

The inventors conducted a second study to measure the memorability of the images. This study followed a memory game procedure. Participants were shown 130 image ads (2 seconds per image, with a 0.5 second interstimulus interval) and asked to press the space bar to indicate that the image ad was repeated. Participants were told they would receive a bonus for accurately identifying images as new or as repeated. Over 85% of the participants received this bonus by satisfying our internal accuracy criterion of 80%. The following analyses were conducted with and without the participants who did not earn a bonus. No qualitative differences in the results were obtained. To assess memory performance, 10 of the 130 images were selected as target items and repeated once with a spacing of 91 to 123 images. This approximately four-minute time window for each target image pair allowed the inventors to measure memorability beyond short-term and working memory effects. An additional 20 images were selected as filler items and repeated once with a spacing of 4 to 8 images, and the remaining 70 images were shown only once.

The images were presented following a PBIB design such that all pairs of the target images and single images were presented to the same number of participants. Five hundred AMT workers with an approval rate of at least 95% participated in the study for each of the three FF chains. Each target image was presented twice to 50 workers and once to 350 workers, and these observations were used to arrive at the image's overall hit rate (HR) and false alarm rate (FAR). The inventors converted these measures to a discriminability statistic d′=Φ⁻¹(HR)−Φ⁻¹(FAR), where Φ⁻¹ the inverse of the Normal CDF. In the remainder of this document, this measure is referred to as memorability.

A third and fourth study were conducted to obtain liking and sharing judgments without image ratings. In Study 3, 100 images were presented in random order for two-second intervals and respondents had to indicate that they liked an image by pressing the space bar. Five hundred AMT workers evaluated the images of each FF chain, so a total of n=1,500 AMT workers participated. Study 4 followed a similar approach, except that respondents were asked to indicate that they would share an image by pressing the space bar. When respondents chose to share, they were asked to type a comment to accompany the shared image. As in the “liking” task, a total of n=1,500 AMT workers participated, so that the estimated “sharing” proportions of each image are based on 500 respondents.

In a fifth study, the inventors asked AMT workers to judge the design features of the images. Specifically, after receiving detailed instructions n=600 AMT workers provided binary judgments on the following six image characteristics: a) Quantity of objects—few or many?, b) Details of objects—little or much?, c) Shape of objects—regular or irregular?, d) Similarity of objects—similar or dissimilar?, e) Arrangement of objects—symmetric or asymmetric?, and f) Arrangement of objects—regular or irregular pattern? Each participant rated five images and, similar to the PBIB design in Study 1, each image and all pairs of images were evaluated by the same number of participants. The inventors controlled for AMT workers participating in multiple studies or in the same study by recording their IP addresses.

A reliability analysis, reported below, showed that the measurements of the aesthetic, memorability (discrimination), liking, and sharing characteristics of the images are internally consistent and sufficiently accurate to allow one to form tests to predict the success of an image based on its aesthetic characteristics.

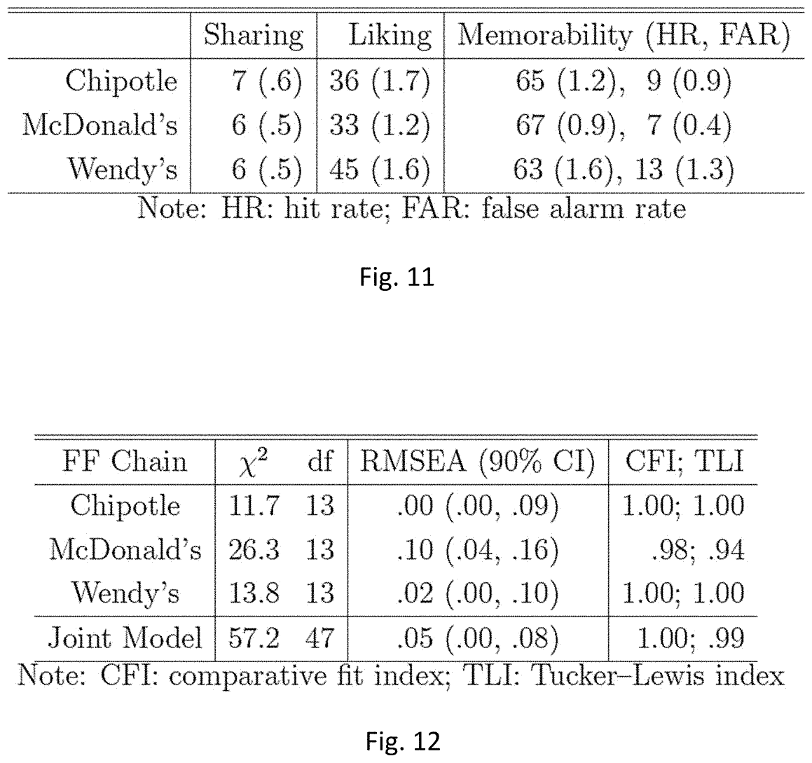

The inventors also explored predicting memorability, liking, and sharing using human image judgments. Specifically, the inventors combined the three data sets to simultaneously analyze the liking proportions, sharing proportions, and memorability measures of the images for each of FF chain. Specifically, the inventors computed the images' liking and sharing proportions from the third and fourth studies and the memorability statistic from the second study. FIG. 11 depicts a table that reports the means of the measures of liking proportions, sharing proportions, and memorability for ads in accordance with an illustrative embodiment. The rightmost column of this table lists the average hit rate (HR) and false alarm rate (FAR). It is noted that the hit rates are comparable across the three FF chains. However, Wendy's image ads score significantly higher on liking than Chipotle's or McDonald's. No appreciable differences are found with respect to image sharing across the three chains.

FIG. 5 presents the marginal distributions as well as the joint relationships between ad measures (with a loess function to highlight any dependencies) in accordance with an illustrative embodiment. The hit rate was included instead of discriminability in the table of FIG. 11 and in FIG. 5 because these measures are obtained directly from the data and not derived. No significant dependencies were found between the hit rates and liking or sharing. However, the association between liking and sharing is positive in that images that are liked are also more likely to be shared.

As described herein, the inventors standardized the ratings of the respondents and aggregated them at the image level. To correct for dependencies at the image level that were not removed by the standardization and aggregation, all reported models were fit with robust standard errors. Moreover, to take into account that the endogenous and exogenous variables are measured with error, reliability estimates were used to adjust the variables' error variances. This approach has been shown to maintain good coverage and Type I error rates in small samples.

The path model, depicted in FIG. 4, was set up as discussed. The two variables typicality and complexity were specified to predict the fluency ratings. Both ‘warm’ and ‘pleasant’ were specified as indicators of the enjoyment triggered by an image, and ‘interesting’ and ‘engaging’ were specified as indicators of the interest elicited by an image. The three variables, typicality, complexity, and fluency, are included as possible predictors of the interest and enjoyment elicited by an image. Finally, the three ad-success measures liking, sharing, and memorability are expressed as a function of the interest and enjoyment factors as well as the typicality, complexity, and fluency measures. It is noted that this specification is more general than depicted in FIG. 4, as it also allows for direct effects of typicality, complexity, and fluency on the ad-success measures.

The inventors fit the measurement-error corrected path model to the data of each FF chain separately as well as jointly. FIG. 12 is a table of fit statistics that point to satisfactory fits for each of the three FF chains supporting the configural-invariance hypothesis that the structural specification across the three data sets is identical in accordance with an illustrative embodiment. FIG. 12 also shows that the fit of the same measurement model to the three chains is not significantly worse than the fits obtained when estimating the path model for each FF chain separately (Δx²=5.4, df=8). Finally, constraining all structural model parameters to be equal across the three groups (with two exceptions) showed significant agreement in the results (Δx²=60.6, df=45). The two exceptions were the patent coefficients of the typicality measure in predicting memorability performance and enjoyment across the three chains. Although this finding of (almost) equal path coefficients is appealing from a parsimony point of view, it is noted that heterogeneity in the path coefficients is likely for different sets of FF chains and samples of images.

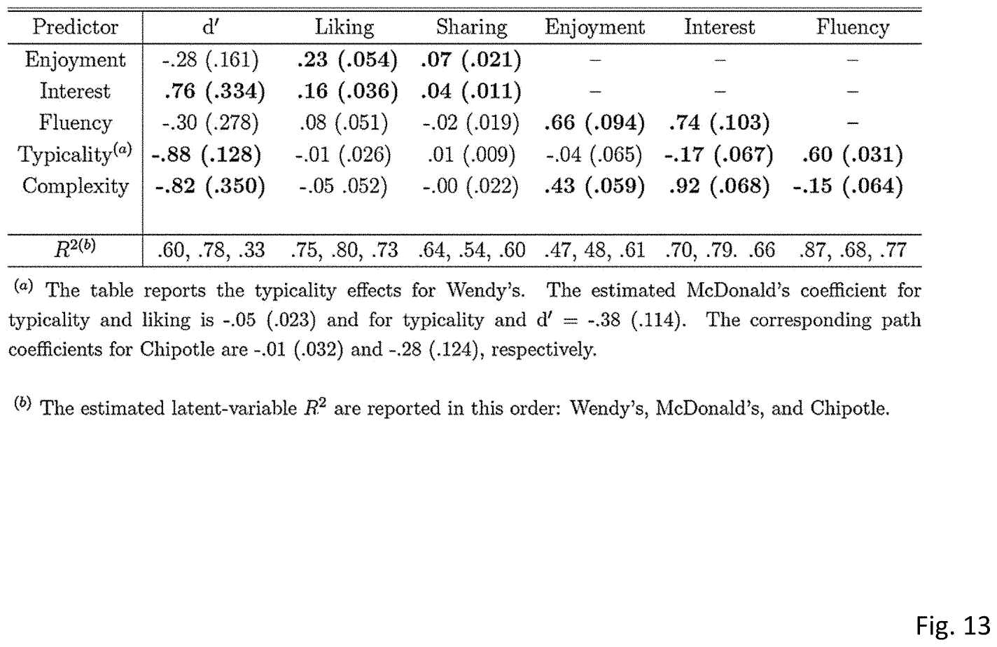

FIG. 13 is a table that presents the estimated standardized path coefficients as well as the latent-variable R² statistics in predicting memorability, liking, and sharing in accordance with an illustrative embodiment. The postulated structure of the path diagram presented in FIG. 4 agrees well with the results of this investigation. Both enjoyment and interest mediate the effects of fluency, typicality, and complexity on liking and sharing. Interest has a positive effect on memorability, liking, and sharing. Enjoyment positively affects liking and sharing but does not have a significant effect on memorability. Images rated high on typicality and complexity receive lower scores on memorability. Fluency mediates the effect of typicality on enjoyment. Images rated high on complexity are associated with higher enjoyment. Interest in image ads is predicted by images that are rated high in fluency and complexity but low in typicality. Finally, fluency is higher for typical images that are also rated lower in complexity.

Although the estimated relationships are consistent with theoretical results that investigated subsets of these constructs, the inventors also obtained additional results. In particular, the direct effects of typicality and complexity on memorability when allowing for enjoyment and interest as mediators add to the literature. However, in contrast to previous studies, it was found that the direct effect of complexity is negative (−0.82 [0.350]) whereas its indirect effect is positive (0.57 [0.277]) in predicting memorability. The finding that enjoyment and interest mediate fully the effects of fluency, typicality, and complexity is also new and shows the importance of these constructs in understanding liking and sharing behaviors.

The data replicate previous results in the literature showing that typicality can mediate the effect of fluency in predicting enjoyment. It is also noteworthy that although complexity is a positive predictor of enjoyment (0.43 [0.059]), it is a much more important predictor of interest (0.92 [0.068]). In contrast, typicality is a more important predictor of fluency (0.60 [0.031]) than complexity (−0.15 [0.064]). It was also found that less typical image ads trigger more interest. Finally, the predicted variance of the liking, sharing, and memorability measures is substantial, with an average of R²=0.66; the only exception is the memorability predictions for Chipotle (R²=0.33). Taken together, these results provide further support for the path-analytic specification in FIG. 4 and add substantially to the theoretical framework on possible links among these constructs.

The inventors also focused on predicting memorability, liking, and sharing using computational image measures. To facilitate the scalability of the proposed approach, the inventors examined and developed computational measures of typicality, complexity, fluency, interest, and enjoyment. Subsequently, these computational measures were analyzed in place of the human ratings to estimate the path-analytic model and predict images that will score better than average on all three ad-success measures.

Computational measures have four important advantages: First, they provide useful insights on how judgments of the five considered constructs are formed. As discussed below, a number of the considered computational measures take into account human processing characteristics that contribute to well-known phenomena of human perception. Second, if a direct link between computational measures and human ratings can be found, on-the-fly image-ad scoring is possible without the need for human judgment or other sources of information. Third, only a relatively small number of images are required to validate the usefulness of a computational measure—in this regard, the approach provides an alternative to deep learning methods that may require a substantial number of well-selected images for the purpose of building robust prediction models. Fourth, a further advantage of using computational measures is the opportunity it provides causal work. By measuring and manipulating, for example, features of an image ad that are known to be related to the considered constructs, one can explore and develop further psychological theories on how human judgments of these image features are formed.

These benefits are especially important when working with real-life stimuli because in this case endogeneity issues cannot always be avoided. For example, exposure to image ads of a brand caused by brand liking may increase typicality experiences and thus confound the hypothesized typicality—liking link. Computational measures are free of such contextual confounders, which simplifies the interpretation of their effects. However, although the focus is on computational measures, deep learning methods can also be applied when computational measures are not available.

Typicality scoring was also performed. A common method to assess the typicality of an exemplar is to ask participants to provide a category goodness-of-fit rating as done in Study 1. Another related method is to give participants a category and ask them to list features of that category (e.g., wings, beak, feathers, etc. for the category bird). Typical members will have more features that overlap with the generated list, whereas atypical members have fewer features. The inventors adopted the second method to create a computational approach that scores the typicality of an image. Because features may be based on objects depicted in an image, on the design relationships among these objects, or on such structural features as pixel intensities, the inventors computed typicality scores using all three considerations.

To obtain a list of objects presented in the images, the inventors used Google Cloud's Vision API. Compared with image recognition services such as Amazon AWS Rekognition, IBM Watson Visual Recognition, and Microsoft Azure Computer Vision, Google Vision is reported to provide the highest accuracy in tagging image contents, and the tags generated by Google Vision are closest to what a human thinks. Next, and separately for each FF chain, the inventors analyzed the resulting list of detected objects for each image using Latent Semantic Analysis (LSA). The first LSA dimension was used as a measure of semantic typicality of the images because it captures the overlap in common terms across the images. Images that score high on this measure show more of the objects that commonly occur in the image ads of each FF chain.

The second measure of typicality was based on the design features of the images. Here the inventors used the DenseNet (i.e., Densely Connected Convolutional Networks) to arrive at predictions of the six design features (i.e., see Study 5). Specifically, the inventors formulated the prediction as a classification problem with four possible outcomes for each of the six design features based on the quartiles of the observed response proportions. Since DenseNet was trained on image classification tasks that differed from what was being used (i.e., design complexity classification), DenseNet was fine-tuned by first randomly splitting the 300 fast-food images into a 200-image training set and a 100-image testing set. The inventors used the 200 training images to fine-tune the pre-trained DenseNet. The resulting prediction accuracy scores of the six design features (i.e., image characteristics mentioned in Study 5: quantity, details, shape, similarity, and symmetric and regular arrangement types) for the 100-image testing set are 0.7, 0.743, 0.684, 0.61, 0.62, and 0.653, respectively. The inventors also considered XGboost and VGG19 with raw image pixels as input but found that the fine-tuned DenseNet performed the best. The inventors used the DenseNet prediction to compute the first dimension of a multidimensional scaling solution based on the distances of these measures across the 300 image ads. This dimension measures the relational similarity across the images as captured by the design features.

The third measure of typicality was derived from the structural similarity measure (SSIM). This measure compares the similarity in the structural information between two images, controlling for luminance and contrast. SSIM is symmetric and takes on the value 1 when two images have identical pixel intensities. The inventors computed SSIM for all pairs of images within a FF chain and extracted the first eigenvector of the resulting matrix as a structural typicality measure of the images. Images that score high on this measure exhibit more structural information than commonly occurs in the chain's image ads.

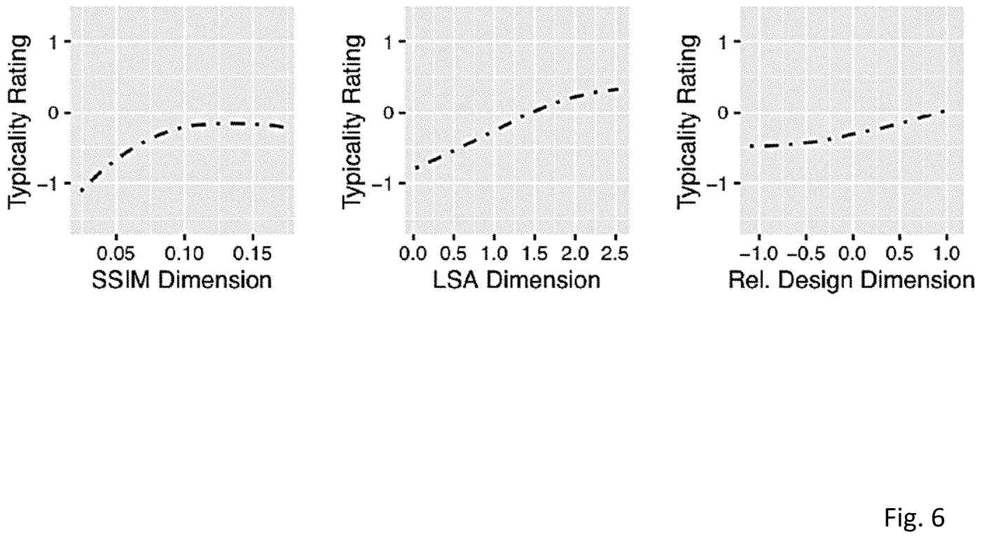

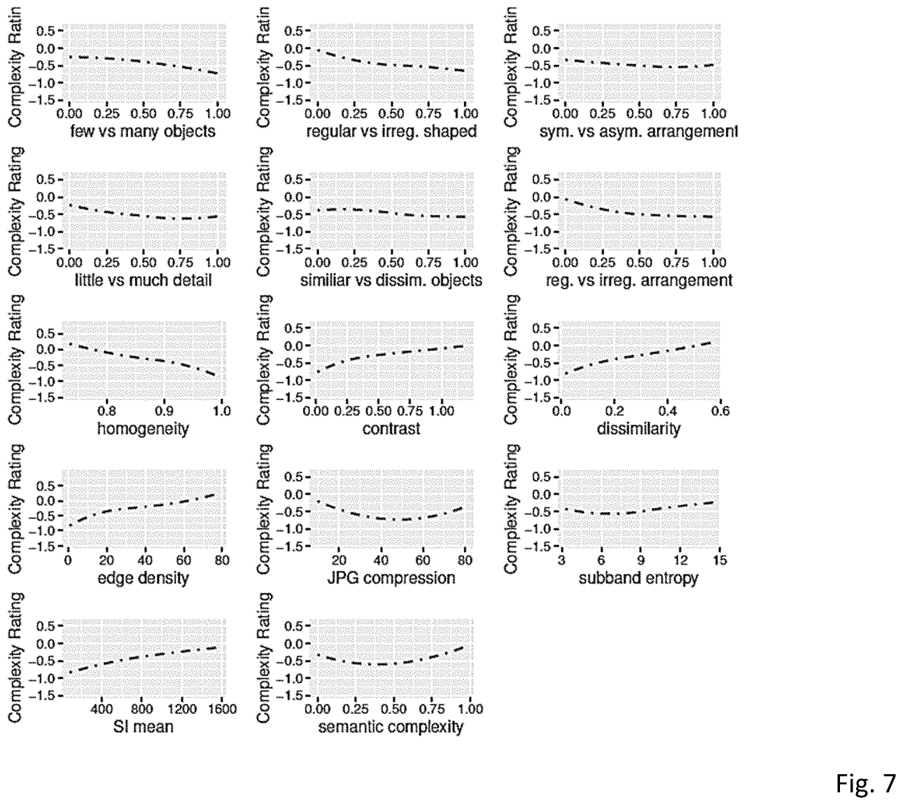

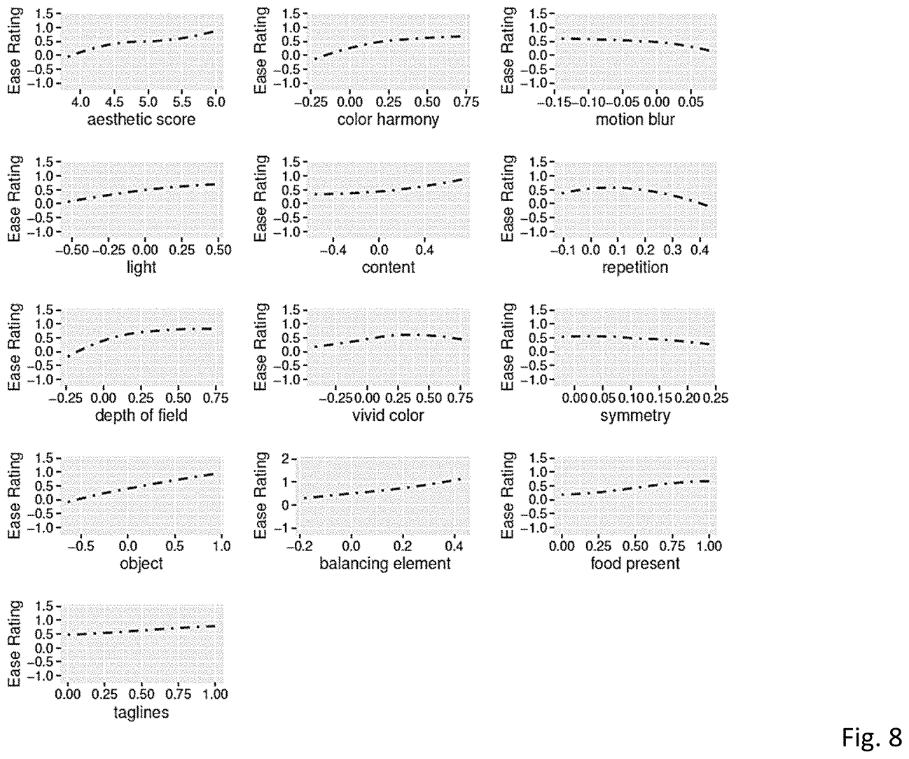

FIG. 6 depicts the loess functions obtained for the object-, relational-, and pixel-based typicality measures and the typicality ratings for the full data set obtained in Study 1 in accordance with an illustrative embodiment. It is noted that the relationships are close-to-linear for the three typicality measures. Moreover, because these computational typicality measures are only weakly correlated, together they account for a substantial percentage of the variance in the image-ad typicality evaluations (R²=0.85 based on 10-fold cross-validation).

The proposed approach differs from that of Mayer and Landwehr (2018), who also utilized computational methods to arrive at typicality measures of car design images. In their context, it was possible to arrive at a prototypical car design by averaging characteristic feature points of a given design: The authors computed typicality based on the Euclidean distance between the averaged and the respective feature points. This approach is not feasible in the proposed application because the used images are not sufficiently homogeneous for an average to be meaningful. However, the results show that there are multiple ways to assess typicality by capturing similarity at the pixel level, the object level, and between the relational features of the objects.

The strongest predictor of the three computational measures is based on the semantic similarity of the identified objects in each image. Specifically, image ads are judged as more typical if they contain objects that can also be found in other images. The second strongest predictor is based on the relational features of the objects. Structural similarity features are also found to affect typicality assessments of the images. The importance order of these predictors is a potentially important finding because it suggests systematic ways to manipulate the typicality of image ads. For example, by varying the semantic overlap of images, one can assess experimentally the causal effect of this image characteristic on typicality assessments. However, it is noted that the computational typicality scoring is specific to the selected sample of image ads. It is an empirical question whether the obtained scoring is stable and remains invariant over time. For example, variations in the ad strategy and/or product offerings can have a significant impact on the typicality scores. In the same way, as human typicality judgments can be task-dependent and context-specific, the scoring may need to be updated and revised to adapt to a changing marketplace.

Complexity scoring was also performed. The experience of image complexity is related to the perceptual load in processing an image. Over the years, a substantial number of measures have been proposed to capture this perceptual load, demonstrating that the construct of experienced image complexity is probably multi-determined. In the present application, several types of computational measures of image complexity were considered.

First, previous research has shown that pixel-based features of an image that capture the brightness of each pixel in relation to neighboring pixels predict subjective complexity ratings. These features can be measured via intensity contrast, homogeneity, and dissimilarity. The intensity contrast is defined between pixels and their neighbors over the whole image, i.e., Σ_{i,j}|i−j|²p(i,j), where p(i,j) is the element i,j of the normalized symmetric GLCM (Grey Level Co-occurrence Matrix). Since an image is composed of pixels, each with an intensity (a specific gray level), the GLCM is a tabulation of how often different combinations of gray levels co-occur in an image or image section. The contrast measure is 0 for a constant image. Homogeneity represents the closeness of the distribution of the elements in the GLCM with respect to the GLCM diagonal and is computed as

$${\sum }_{i , j} \frac{p ( i , j )}{1 + {\vert i - j \vert}^{2}} .$$

The homogeneity measure is 1 for a diagonal GLCM. The dissimilarity measure indicates the degree to which an image forms clusters in the feature space. Contrast and homogeneity are computed on grayscale images and do not take into account color information. Both measures capture important properties of the GLCM and are widely used for image texture analysis and classification. In contrast, the dissimilarity measure considers the color information of an image (e.g., its raw pixel values) and is calculated based on its distance to the centroid of the FF images.

Second, in addition to these low-level or unstructured complexity measures, research has also shown that more high-level visual features such as color, luminance, and edges, measured by the percentage of edge pixels (e.g., edge density), clutter relations (e.g., sub-band entropy), and compression ratios (e.g., JPEG compression), also affect human complexity perceptions. In addition, compression-based and spatial information-based (SI-based) methods have been developed. Here, the inventors use the SI mean, which is an indicator of edge energy, as a measure of image complexity. This measure is calculated as the mean of the SI values across all the pixels in an image where SI represents the magnitude of spatial information at every pixel and is defined as SI=\sqrt{sₕ²+sᵥ²}, with sₕ and sᵥ denoting grayscale images filtered with horizontal and vertical Sobel kernels, respectively.

Third, structural features of images as represented by shapes, objects, and their relationships have been shown to increase the experienced visual complexity of an image. Specifically, researchers have identified several Gestalt categories capturing the number of objects, the details of the objects, the shape of the objects, the similarity among the objects, and arrangement of objects. As noted above with respect to typicality scoring, the inventors implemented the fine-tuned DenseNet to arrive at predictions of the six design features.

As a semantic measure of object overlap, the inventors computed the average similarity of the objects within an image. Images that score high on semantic similarity may be viewed as more complex. Google Cloud Vision API was used to obtain up to 10 objects for each image. Each object word was then represented as a 300-dimensional vector using one of the most popular word embedding models (i.e., word2vec) developed by Google. This word2vec model is pre-trained on the Google News data set (about 100 billion words). The similarity of two object words is measured by the cosine of their corresponding 300-dimensional vectors learned via word2vec. The inventors define the semantic complexity of an image as the average similarity over all possible pairs of the object words.

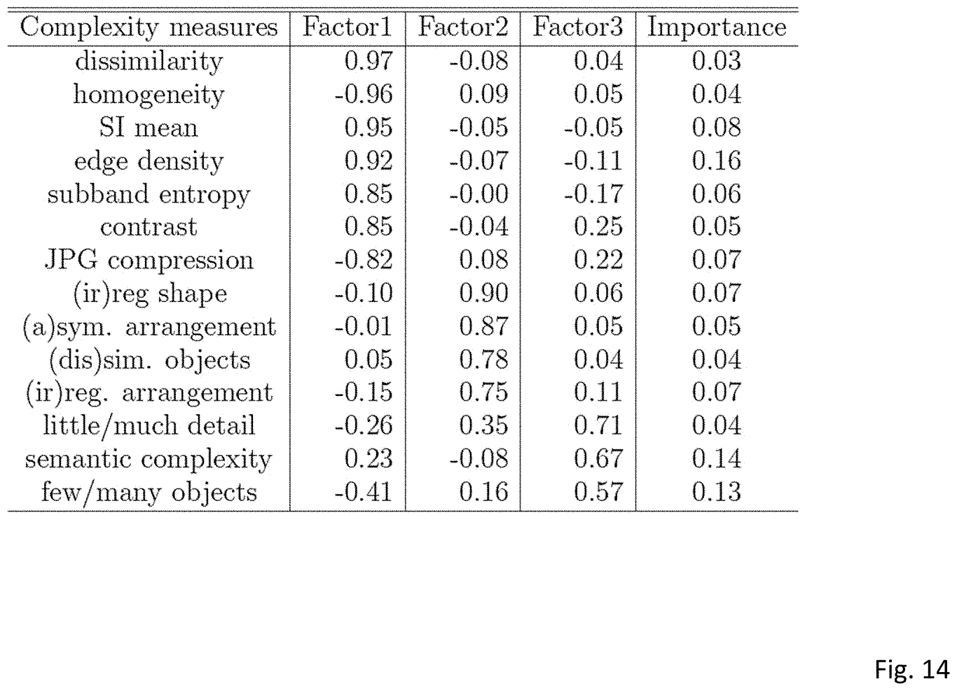

To investigate the internal relationships among these different measures of complexity, a principal component analysis with a varimax rotation was conducted. FIG. 14 shows results of this analysis in the form of factor loadings and importance weights of complexity measures. Specifically, FIG. 14 is a table that reveals a three-factor structure (accounting for 74% of the total variance) with pixel-based measures forming one dimension in accordance with an illustrative embodiment. Shape, arrangement, and similarity among objects formed a second dimension, and the level of detail, as well as semantic complexity, formed the third dimension. All loadings conform to a simple structure with the exception of the number of objects, which cross-load both on the first and third dimensions. It is concluded that the distinction between pixel- and design-based measures of complexity is well supported by the results, but the inventors add that design-based complexity may be separated further into an object-configuration dimension and a level of detail dimension.

FIG. 7 shows that the loess functions for the fourteen complexity measures in predicting the complexity rating are close-to-linear in accordance with an illustrative embodiment. The last column of FIG. 14 lists the importance weights of these measures obtained in a random forest regression. Edge density, semantic complexity, and the number of objects appear as the most important predictors of the complexity ratings.

Regarding fluency scoring, it has been noted that images that are processed more fluently receive a more positive aesthetic response. It has also been found that such aesthetic features as the goodness of form, symmetry, or figure-ground contrast provide measures of perceptual fluency, whereas features that simplify mental operations targeted at the meaning of a stimulus may be used as measures of conceptual fluency. Following these observations, the inventors created two distinct variable groups to capture the subjective feeling of ease associated with mental processing.

As indicators of perceptual fluency, the first variable group includes eleven attributes designed to assess image aesthetics. An aesthetics and attributes database (AADB) of 10,000 images from the Flickr website was used as part of this analysis. This database is useful because it includes a wide range of images from distinct domains, including fast-food. The authors asked AMT workers to annotate each image with an overall aesthetic score and the following eleven attributes that measure distinct aesthetic features: a) “balancing element”—whether the image contains balanced elements, b) “content”—whether the image has good/interesting content, c) “color harmony”—whether the overall color of the image is harmonious, d) “depth of field”—whether the image has a shallow depth of field, e) “lighting”—whether the image has good/interesting lighting, f) “motion blur”—whether the image has motion blur, g) “object emphasis”—whether the image emphasizes foreground objects, h) “rule of thirds”—whether the photography follows the rule of thirds, i) “vivid color”—whether the photo has vivid color, not necessarily harmonious color, j) “repetition”—whether the image has repetitive patterns, and k) “symmetry”—whether the photo has symmetric patterns.

The inventors applied a trained model to obtain scores on the eleven image attributes and the overall aesthetic evaluation of the FF images. The trained model was developed by first fine-tuning a basic front-end architecture using a Euclidean loss function for predicting the overall aesthetic ratings. Next, the model was trained through a Siamese network, which takes image pairs as input and predicts which image obtained higher aesthetic ratings. Finally, the model incorporated a predictor for subsequent applications (e.g., a fully connected feedforward neural network for aesthetic scoring or image attribute classification).

The second variable group focuses on measuring conceptual fluency and includes two variables, the first indicating whether food is depicted in an image and the second indicating whether the image contains a tag line. The depiction of food item(s) in an FF image as well as the availability of tag lines simplify the interpretation of the image and should make it easier to understand. Google Cloud's Vision API was used to identify the presence of food items and tag lines in the image ads.

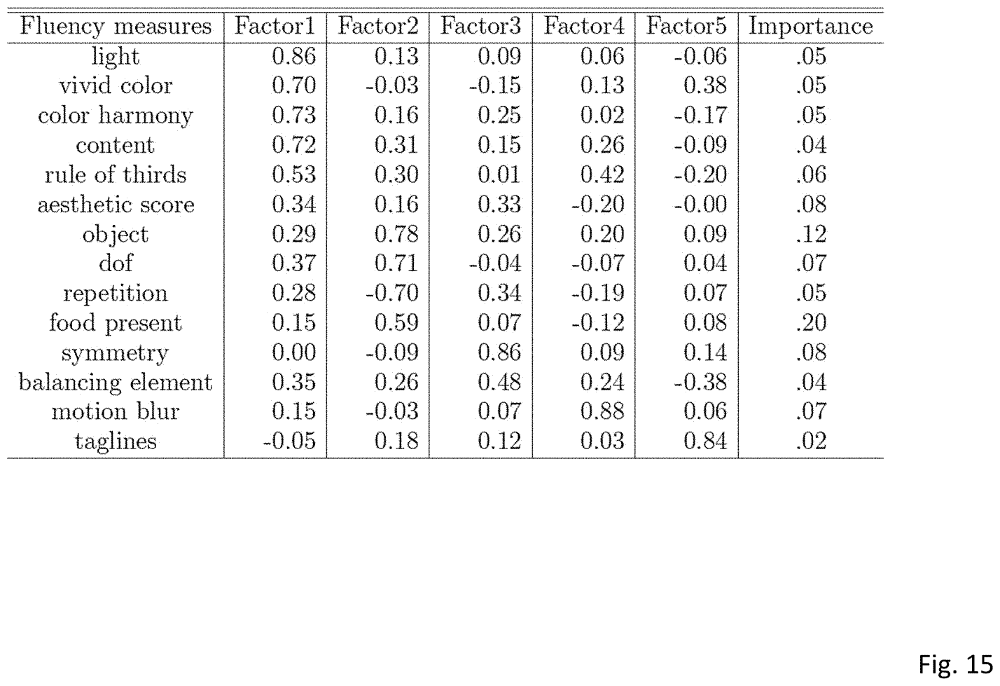

FIG. 8 shows that the loess functions for the fourteen computational fluency measures in predicting the ease rating are close-to-linear in accordance with an illustrative embodiment. FIG. 15 is a table of factor loadings and importance weights of fluency measures in accordance with an illustrative embodiment. Importantly, the average correlations between these measures are modest, as also shown by the results of a principal component analysis. Even the extraction of five factors accounts for only 66% of the variance. Moreover, the component loadings in the table of FIG. 15 do not pick up on the conceptual and perceptual fluency distinction and do not offer a readily interpretable structure.

The last column of FIG. 15 lists the importance weights of these measures obtained in a random forest regression. Images that depict food and contain foreground objects are particularly easy to understand. The inventors conclude that the “easy-to-understand” rating of an image is related to measures of both perceptual and conceptual fluency. However, among this set of variables, tag lines are less important for predicting the easy-to-understand ratings of the image ads.

Interest and enjoyment scoring is discussed below. In contrast to the typicality, complexity, and fluency constructs, no prior research has focused on developing pixel-based indicators of enjoyment and interest. The inventors therefore developed an ad-hoc approach to obtain scores that are predictive of the image ads' interest and enjoyment evaluations. Specifically, the inventors developed a simple but effective word2vec-based algorithm where each feature (i.e., object word) of an image identified by Google Cloud's Vision API and each of four attribute words—interesting, engaging, warm, and pleasant—are represented as a 300-dimensional vector using the pre-trained Google word2vec model. The inventors computed the cosine similarities between an image feature and attribute words and averaged these similarity measures for each image. Thus, images that received a high positive score on an attribute contained at least one image feature that received a high similarity score for that attribute. The resulting similarity scores proved to be useful as predictors of the human ratings in a random forest regression. The average R² under 10-fold cross-validation for interesting, engaging, warm, and pleasant were 0.825, 0.789, 0.826, and 0.832, respectively. Other machine learning models such as XGBoost yielded similar results.

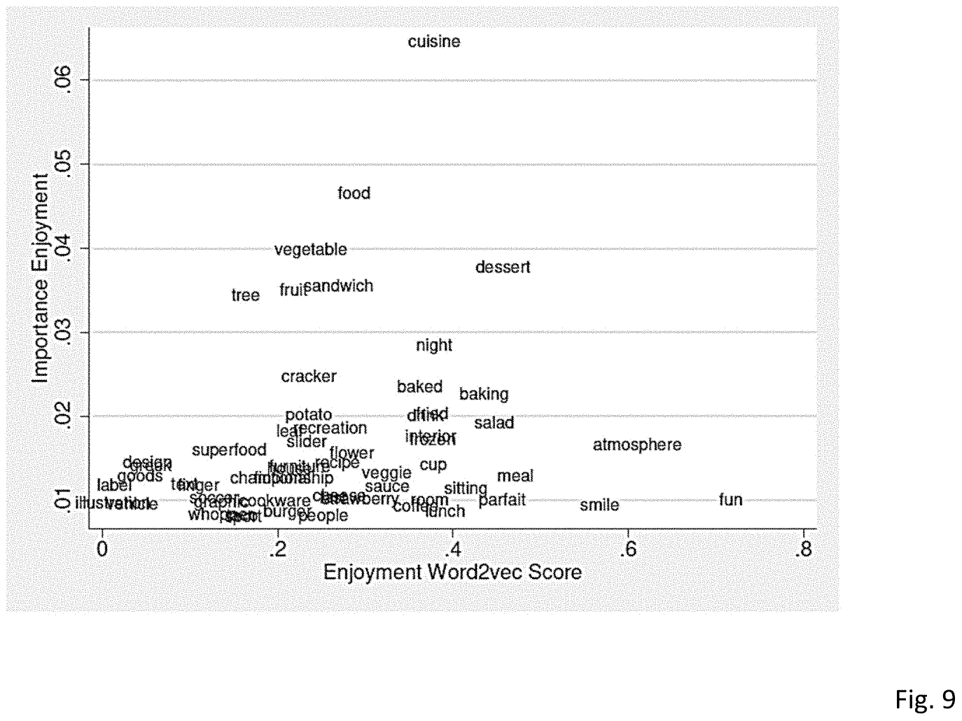

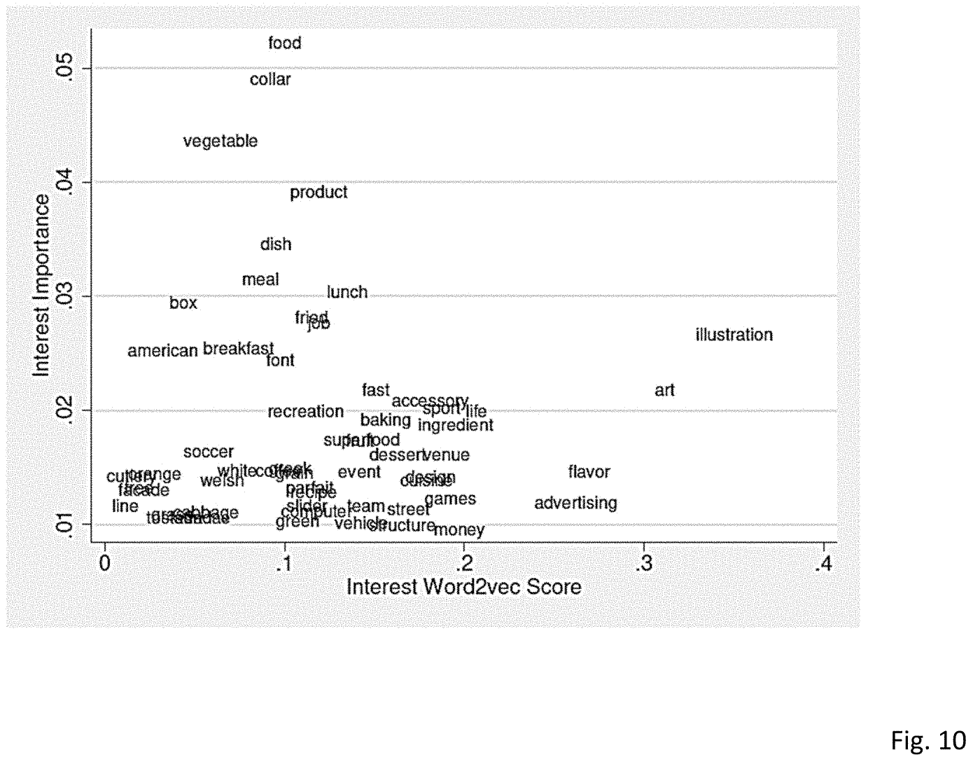

FIGS. 9 and 10 summarize key parts of this approach. FIG. 9 displays a scatter plot of the summed importance weights for the pleasant and warm attributes against the corresponding summed word2vec scores for the top 10% of the identified features in accordance with an illustrative embodiment. It is noted that predominantly, food and ingredient features (e.g., fruit, dessert, vegetable, potato) predict the enjoyment attributes. Other enjoyment-related features such as atmosphere, smile, and fun also play a role but to a smaller degree.

FIG. 10 depicts a scatter plot of the importance weights for the engaging and interesting attributes versus corresponding word2vec scores in accordance with an illustrative embodiment. To obtain FIG. 10, the inventors followed the same procedure using the interesting and engaging importance weights and corresponding word2vec scores. Here, it was also found that food-related items are predictive but, in addition, the display type (e.g., art, illustration), activity-related features depicted in the image ad (e.g., recreation, games, soccer), and style-related features (e.g., font, text, label) also prove to be predictive.

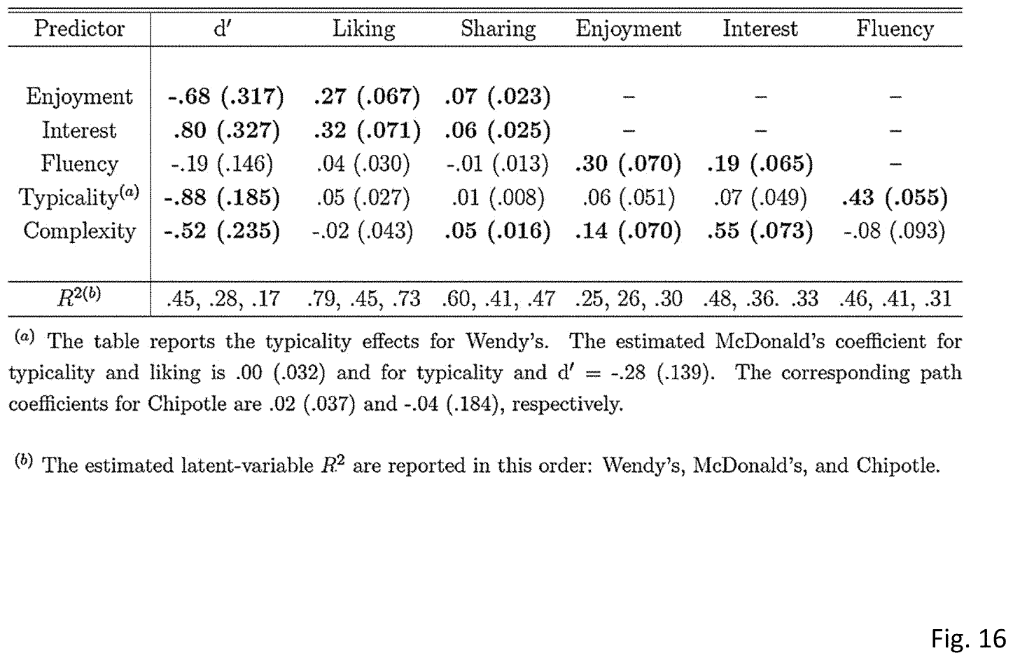

To assess the predictive performance of the computational approach, the inventors withheld 33% of the image ads for each FF chain. For this hold-out sample, the predicted computational scores were obtained and the path model presented FIG. 4 was rerun with memorability, liking, and sharing as dependent variables. In contrast to the path model of the rating data, no measurement error correction was used for the computational scores. FIG. 16 depicts results obtained when using the computational scores of the hold-out sample in accordance with an illustrative embodiment. More specifically, FIG. 16 shows estimated path coefficients (standard errors) of the three FF chains using computational measures. It was concluded that the path model fits satisfactorily (x²=117.3, df=95).

Comparing FIGS. 13 and 16, the structural links between the predictors and dependent variables are very similar to the ones found with human ratings. However, the predictive strength of the computational scores as measured by R² is substantially lower, especially for the McDonald's image ads. Two possible reasons for this result stand out. First, no measurement error correction was used when estimating the computational scores and when including them in the path model. Second, the standard errors of the estimated R2 are substantial, at around 0.08, indicating that they exhibit significant sampling variation introduced by the smaller size of the hold-out sample. However, despite these limitations, the obtained findings are encouraging and suggest that the computational scores are useful in capturing the key relationships between the underlying constructs and the success metrics of the FF image ads.

Identifying the best ads was also considered. To further examine the usefulness of the computational scores for predicting ad success, the inventors created an indicator variable that identified the brand images that are simultaneously in the top half on liking, sharing, and memorability. For the hold-out sample, this resulted in 17 images. A Bayesian probit path-analytic model was used to predict this set of images. This model yielded a posterior mean AUC statistic of 0.80 (0.05). This result further demonstrates that the computational scoring provides an acceptable approach to identify images that perform well on all of the three image-ad success measures.

As noted above, the inventors did not use the original liking and sharing counts associated with each image ad because due to ad-targeting algorithms, these statistics are likely to be biased measures of the true liking and sharing characteristics of the images. However, significant positive relationships were found between the original measures and the ones obtained in the survey. A bivariate loglinear regression model with the original liking and sharing counts as dependent variables, the survey liking and sharing proportions as independent variables and food-chain intercepts yielded \hat{β}_{Liking}=1.69 (p<0.016; R²=0.29) and \hat{β}_{Sharing}=6.74 (p<0.003; R²=0.21).

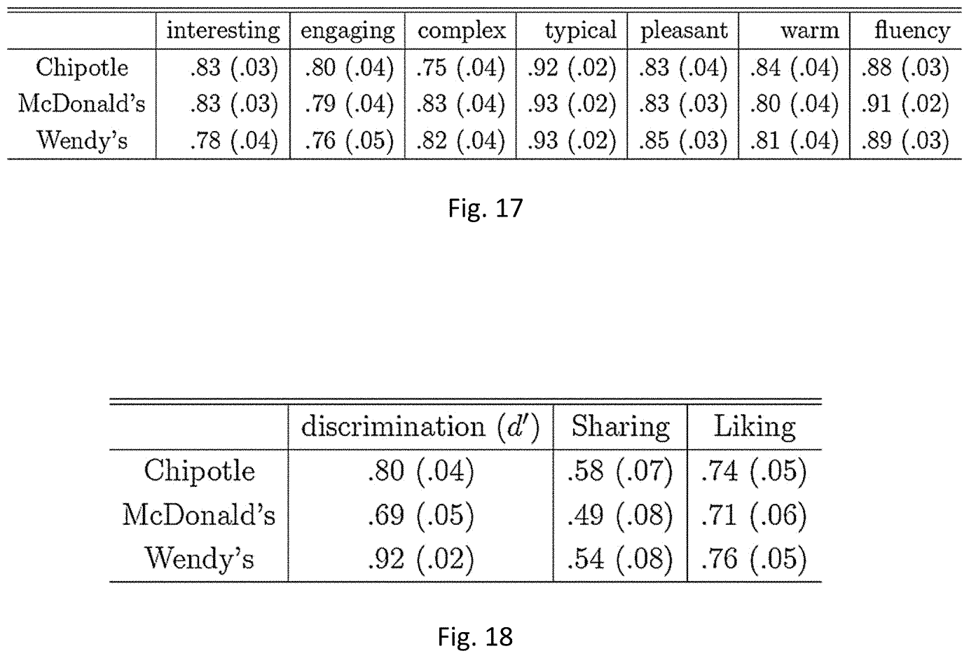

Additionally, to examine the internal consistency of these proportions and the other measures obtained in our empirical studies in discriminating among the FF chain images, the inventors also conducted a detailed reliability analysis. Since the number of images is large, the reliability of the memorability (discrimination) measure, aesthetic characteristics, and the liking and sharing variables were estimated at the image level by using the split-half method. The inventors split the group of participants randomly into two halves and computed the Pearson correlation between them across the 100 images for each of the three FF chains. This procedure was repeated 1,000 times. FIG. 17 is a table that depicts average estimated reliability coefficients with their standard errors for the ratings obtained in Study 1 in accordance with an illustrative embodiment. Overall, this analysis signals that the measurement of image differences on these various measures is rather satisfactory.

FIG. 18 contains the reliability estimates for the discrimination, sharing, and liking measures in accordance with an illustrative embodiment. It is noted that the reliability of the sharing measure is substantially lower than the reliability coefficients for the other image characteristics. This result is caused by the low sharing incidence in the data (see FIG. 11). In addition to these internal consistency measures, the inventors also calculated the correlations between the liking proportions obtained in Studies 1 and 3 and between the sharing proportions obtained in Studies 1 and 4. For liking, the correlations are 0.72, 0.69, and 0.74 for Chipotle, McDonald's, and Wendy's, respectively, and for sharing, the corresponding correlations are 0.55, 0.44, and 0.49.

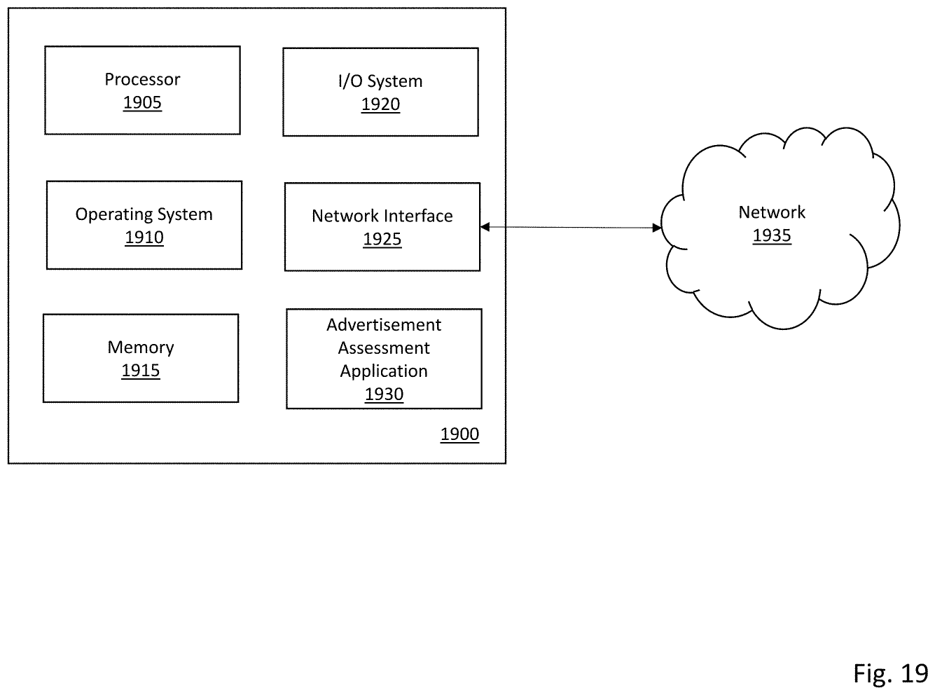

FIG. 19 is a block diagram of a computing device 1900 for implementing the system described herein in accordance with an illustrative embodiment. The computing system 1900 can be in the form of any type of networked computing device such as a laptop computer, desktop computer, smart phone, dedicated computing sub-system, etc. The computing system 1900 includes a processor 1905, an operating system 1910, a memory 1915, an input/output (I/O) system 1920, a network interface 1925, and an advertisement assessment application 1930. In alternative embodiments, the computing system 1900 may include fewer, additional, and/or different components. The components of the computing system 1900 communicate with one another via one or more buses or any other interconnect system.

The processor 1905 can be any type of computer processor known in the art, and can include a plurality of processors and/or a plurality of processing cores. The processor 1905 can include a controller, a microcontroller, an audio processor, a graphics processing unit, a hardware accelerator, a digital signal processor, etc. Additionally, the processor 1905 may be implemented as a complex instruction set computer processor, a reduced instruction set computer processor, an x86 instruction set computer processor, etc. The processor 1905 is used to run the operating system 1910, which can be any type of operating system.

The operating system 1910 is stored in the memory 1915, which is also used to store programs, algorithms, network and communications data, peripheral component data, the advertisement assessment application 1930, and other operating instructions. The memory 1915 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 1920 is the framework which enables users and peripheral devices to interact with the computing system 1900. The I/O system 1920 can include a mouse, a keyboard, one or more displays, a speaker, a microphone, etc. that allow the user to interact with and control the computing system 1900. The I/O system 1920 also includes circuitry and a bus structure to interface with peripheral computing devices such as power sources, USB devices, peripheral component interconnect express (PCIe) devices, serial advanced technology attachment (SATA) devices, high definition multimedia interface (HDMI) devices, proprietary connection devices, etc. In an illustrative embodiment, the I/O system 1920 presents an interface to the user such that the user is able to control the system.

The network interface 1925 includes transceiver circuitry that includes a receiver and a transmitter, and that allows the computing system 1900 to transmit and receive data to/from other devices such as remote computing systems, servers, websites, etc. The network interface 1925 also enables communication through a network 1935, which can be one or more communication networks. The network 1935 can include a cable network, a fiber network, a cellular network, a wi-fi network, a landline telephone network, a microwave network, a satellite network, etc. The network interface 1925 also includes circuitry to allow device-to-device communication such as Bluetooth® communication.

The advertisement assessment application 1930 can include software in the form of computer-readable instructions which, upon execution by the processor 1905, performs any of the various operations described herein such as receiving image ads, segmenting the image ads to identify features, comparing identified features to known attributes and/or thresholds, determining a likelihood of success of the advertisement, running algorithms, solving equations, etc. The advertisement assessment application 1930 can utilize the processor 1905 and/or the memory 1915 as discussed above. In an alternative implementation, the imaging application 1930 can be remote or independent from the computing system 1900, but in communication therewith.

In general, predicting the success of image ads is a difficult task. A purpose of the proposed system is to simplify this task by considering several key constructs that play important roles in liking an image, in a decision to share it, and in remembering it. The inventors focused on such perceptual constructs as the typicality and complexity of an image and examined how they can affect the ease of understanding an image. The inventors also showed that these constructs are important in eliciting judgments of interest and enjoyment which, ultimately, are the key drivers in liking and sharing an image.

Although liking, sharing, and remembering image ads are a result of multiply determined processes, the proposed conceptual framework plays a significant role in this context. The framework allows multiple constructs to be studied jointly, which is necessary to understand the separate mediating and moderating roles of each construct. Moreover, the investigation and application of computational measures of the constructs instead of human ratings show that the framework is scalable, which as discussed herein, has significant implications for both theoretical and applied work.

The conceptual framework is informed by the vision and aesthetics literature as well as by numerous studies that examined subsets of the considered constructs in the context of image perception. Importantly, the approach ignores contextual features of ad perception and operates at the image level alone. The inventors focus on image features and not on consumer differences, past experiences, or other factors that can affect whether an image ad is liked, shared, or remembered. However, it is noted that this approach can allow for consumer-related sources of variation, although these sources were not considered in the work because many computational measures of image content are not sufficiently advanced to consider individual differences in perception. In sum, it is believed that the presented theoretical framework offers a rich set of opportunities to deepen our understanding of why image ads are liked, shared, and remembered and that this framework will ultimately advance practices in image-ad effectiveness research.

Any of the embodiments described herein can be implemented by a computing system that includes a processor, a memory, user interface, transceiver, etc. Specifically, any of the operations described herein can be implemented as computer-readable instructions stored in the memory. Upon execution of these computer-readable instructions by the processor, the computing system performs the actions described herein.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system to predict success of advertisements, the system comprising:
a memory configured to store an advertisement; and
a processor operatively coupled to the memory and configured to:
identify one or more features of an image included in the advertisement;
identify similarities between the one or more features and one or more defined attributes;
determine a typicality of the advertisement based at least in part on the similarities between the one or more features and the one or more defined attributes; and
assign a likelihood of success score to the advertisement based at least in part on the typicality.

2. The system of claim 1, wherein the one or more features include one or more object words.

3. The system of claim 1, wherein the one or more features include a depiction of an item of food.

4. The system of claim 1, wherein the processor is further configured to identify a relational feature between objects within the image included in the advertisement.

5. The system of claim 4, wherein the processor determines the typicality of the advertisement based at least on part on the relational feature between the objects within the image.

6. The system of claim 1, wherein the processor is configured to estimate a level of interest in the advertisement based at least in part on the similarities between the one or more features and the one or more defined attributes.

7. The system of claim 6, wherein the likelihood of success score is based at least in part on the estimated level of interest.

8. The system of claim 1, wherein the processor is configured to estimate a level of enjoyment that the advertisement provides based at least in part on the similarities between the one or more features and the one or more defined attributes.

9. The system of claim 8, wherein the likelihood of success score is based at least in part on the estimated level of enjoyment.

10. The system of claim 1, wherein the processor is configured to estimate a fluency level of the advertisement based at least in part on the similarities between the one or more features and the one or more defined attributes.

11. The system of claim 10, wherein the likelihood of success score is based at least in part on the estimated fluency level.

12. The system of claim 1, wherein the processor is configured to estimate an amount of complexity of the advertisement based at least in part on the similarities between the one or more features and the one or more defined attributes.

13. The system of claim 12, wherein the likelihood of success score is based at least in part on the estimated amount of complexity.

14. The system of claim 1, wherein the one or more defined attributes indicate a likelihood of sharing.

15. The system of claim 1, wherein the one or more defined attributes indicate a likelihood of being liked on social media.

16. The system of claim 1, wherein the one or more defined attributes indicate a likelihood of being remembered.

17. A method of predicting success of advertisements, the method comprising:
storing, in a memory, an advertisement;
identifying, by a processor operatively coupled to the memory, one or more features of an image included in the advertisement;
identifying, by the processor, similarities between the one or more features and one or more defined attributes;
determining, by the processor, a typicality of the advertisement based at least in part on the similarities between the one or more features and the one or more defined attributes; and
assigning, by the processor, a likelihood of success score to the advertisement based at least in part on the typicality.

18. The method of claim 17, further comprising:
identifying, by the processor, a relational feature between objects within the image included in the advertisement; and
determining, by the processor, the typicality of the advertisement based at least on part on the relational feature between the objects within the image.

19. The method of claim 17, further comprising estimating, by the processor, a level of interest in the advertisement based at least in part on the similarities between the one or more features and the one or more defined attributes, wherein the likelihood of success score is based at least in part on the estimated level of interest.

20. The method of claim 17, further comprising estimating, by the processor, a level of enjoyment that the advertisement provides based at least in part on the similarities between the one or more features and the one or more defined attributes, wherein the likelihood of success score is based at least in part on the estimated level of enjoyment.
